(19) United States
(12) Patent Application Publication
(10) Pub. No.: US 2018/0144661 A1
(43) Pub. Date: May 24, 2018

(54) ARTIFICIAL ROOT CANAL SIMULATOR BASED ON HYDROXYAPATITE

(71) Applicants: INSERM (INSTITUT NATIONAL DE LA SANTE ET DE LA RECHERCHE MEDICALE), Paris (FR); UNIVERSITE DE VALENCIENNES ET DU HAINAUT CAMBRESIS, Valenciennes Cedex 9 (FR); UNIVERSITE DE LILLE 2 DROIT ET SANTE, Lille (FR); CENTRE HOSPITALIER REGIONAL ET UNIVERSITAIRE DE LILLE (CHRU), Lille (FR)

(72) Inventors: Lieven ROBBERECHT, Loos (FR); Jean-Christophe HORNEZ, Valenciennes (FR); Feng CHAI, Loos (FR); Etienne DEVEAUX, La Madeleine (FR); Anne LERICHE, Hautrage (BE); Vincent HORNEZ, Eth (FR); Thibault BECAVIN, Loos (FR); Marion DEHURTEVENT, Loos (FR)

(21) Appl. No.: 15/575,668

(22) PCT Filed: May 26, 2016
(86) PCT No.: PCT/FR2016/051241

§ 371 Date: Nov. 20, 2017

(30) Foreign Application Priority Data
May 27, 2015 (FR) 15 54777

(51) Int. Cl. G09B 23/28; G09B 23/30; G09B 9/00

(52) U.S. Cl. CPC G09B 23/283; G09B 9/00; G09B 23/30; G09B 23/286

(57) ABSTRACT

The present invention relates to an artificial root canal simulator based on hydroxyapatite, comprising a cavity representing a root canal, said artificial root canal simulator having a porosity of between 10% and 40% and a Vickers hardness of 50 to 200 HV, and to a method for the manufacture of an artificial root canal simulator according to the invention.

The present invention relates to an artificial endodontic canal simulator and a method for manufacturing such an artificial endodontic canal simulator.

In dental surgery, the conservation and restoration of teeth are vital in the treatment of patients. Endodontic treatment (root canal) is necessary when the pulp tissue, at the core of the tooth, is altered following an attack starting with decay, trauma or infection, or when the reconstruction of the tooth requires the fitting of a pin in the root. Such endodontic treatment typically comprises cleaning, blocking the canal system (containing the neurovascular bundle) and the three-dimensional filling thereof, according to the state of the art. However, this method cannot be reproduced from one patient to another, because of the significant complexity and variability of the shape of the canal system.

The development of new endodontic materials and new endodontic techniques, as well as them being learned by practitioners are currently carried out either on natural teeth of human or animal origin, or on artificial canal simulators.

However, the use of human teeth is limited because of significant variations (connected to the anatomy, age and pathological history of the teeth), risks of cross infections and difficulties inherent to obtaining them, whether for university use or for research purposes.

Artificial canal simulators represent an advantageous alternative and more and more widely used for research and education purposes. A material block which comprises (in hollow) a cavity defining a root canal of a tooth, is called an “artificial endodontic canal simulator”. In other words, a “negative mould” that has the form of the volume of a canal part of the root of a tooth is reproduced in the material block. Typically, a canal part of the dental root has a cross-section decreasing from the coronal area to the tip of the root or apical area of the tooth. Such a simulator enables, for example, the implementation of endodontic treatment tests when the element has a composition close to the natural tooth.

Most artificial canal simulators available are resinous canal simulators. Typically, artificial canal simulators are made from acrylic resin, for example, from poly(methyl methacrylate) (PMMA).

The application FR2723240 defines, for example, the production of copies of teeth in transparent epoxy resin. These artificial teeth are made by moulding a root part and a coronary part, respectively associated after the creation of root canals. These are reproduced simplistically by having one or several rectilinear or conic metal protectors in the epoxy resin material, in order to form the canals.

These resinous simulators are standardised, but they are limited by their composition and their microstructure, far away from the natural tooth, their simplistic canal shape and their clear radio character which does not enable to simulate the X-ray density of natural teeth, in particular during practical work.

The resulting mechanical properties are truly different from those of natural dentine. The use of heating instruments, for example, makes the PMMA fuse. These major differences in effect limit their use under conditions usually implemented on the natural tooth.

Moreover, other materials have been tested for manufacturing artificial canal simulators.

The patent application EP 2 011 451, for example, relates to an artificial tooth comprising an enamel portion and a dentine portion that have different textures. Dentine can be formed with a body sintered with an inorganic powder, a resin or a composite, but the model more specifically defined in this application is composed mainly of zirconia and alumina. This artificial tooth is reproduced by a ceramic injection process (in particular, by forming granules with alumina and a binding agent), injecting granules in a mould, removing the binding agent by high-temperature heat and sintering treatment. The temperature used for sintering results in a partial densification of the material in order to preserve a porosity which then enables the impregnation of a resin.

Moreover, the formation of a pulp volume (comprising dental canals) inside dentine is carried out via the use of a mould made from combustible material (for example, an epoxy resin), that has the desired pulp form. When the ceramic injection process has finished, the product obtained is calcinated in order to remove the combustible material mould and to leave an empty space representing the form of the pulp volumes. This space is then filled with a resin, silicon rubber, wax or a soluble material.

However, the composition of this simulator is still quite far away from natural dentine, composed mainly of hydroxyapatite.

There is still currently a need for an endodontic canal simulator, of which the structure is close to natural dentine, at least in the mineral phase of natural dentine.

An aim of the invention is also to supply an artificial endodontic canal simulator which is radiopaque in order to enable the production of X-rays.

Another aim of the invention is to propose a method for the simple and reproduceable preparation of such a simulator, and which can preferably enable the production of root canals biomimetically.

Other aims and advantages will appear during the description which will follow, which is only given for information purposes and which does not aim to limit it.

### SUMMARY OF THE INVENTION

The inventors deserve credit for having developed an artificial endodontic hydroxyapatite-based canal simulator comprising a cavity representing a root canal, said simulator having a porosity of between 10% and 40% and a Vickers Hardness of 50HV to 200HV. Such an artificial endodontic canal simulator, in other words, an artificial reproduction via a negative mould of the canal part of a tooth, and more specifically, the canal part of the root of a tooth, has the advantage of having a composition, a microstructure and an anatomy close to a natural dental root. This simulator reacts to the surrounding conditions (for example, to the temperature, the pressure, the presence of fluid, among other conditions), close to the natural tooth. It is also possible to bind adhesive systems using a micromechanical integration of these adhesive systems to the simulator according to the invention, close to that obtained on natural dentine. Moreover, this canal simulator has the advantage of being radiopaque, and thus being able to be viewed on X-rays.

The invention therefore relates to an artificial endodontic hydroxyapatite-based canal simulator comprising a cavity representing a root canal, said artificial endodontic canal simulator having a porosity of between 10% and 40%, preferably between 10% and 30% and a Vickers Hardness of 50HV to 200HV.

The present invention also relates to a method enabling the manufacture of an artificial endodontic canal simulator according to the invention.

An objective of the present invention thus relates to a method for preparing an artificial endodontic hydroxyapatite-based canal simulator comprising a cavity representing a root canal, said method comprising the steps consisting of:

a) preparing a liquid slush comprising hydroxyapatite, at least one blowing agent, at least one binding agent, at least one dispersing agent and water;

b) pouring said liquid slush into a container wherein a canal mould is placed;

c) drying said liquid slush order to obtain a raw material comprising said canal mould;

d) removing said raw material comprising said canal mould from the container;

e) thermally processing said raw material comprising said canal mould in order to form said cavity defining the root canal by combusting said canal mould and obtaining said artificial endodontic canal simulator.

According to the optional characteristics taken by themselves or in any combination:
said at least one blowing agent is chosen from among starches, organic polymers, graphite and resins, preferably from among starches;
said at least one blowing agent is from rice starch;
said at least one binding agent is chosen from among polyacrylic compounds and polyvinyl compounds, preferably from among polyacrylic compounds;
said at least one binding agent is an acrylic latex;
said at least one dispersing agent is chosen from among water-soluble polymers, homopolymers, organic or inorganic copolymers, preferably of a molar mass of between 10000 g·mol⁻¹ and 40000 g·mol⁻¹;
said at least one dispersing agent is ammonium polymethacrylate;
the reference viscosity μ₀ of said liquid slush is between 8 MPas and 100 MPas, preferably still between 60 MPas and 80 MPas;
the dynamic viscosity μ of said liquid slush is between 0.5 MPas and 30 MPas, preferably still between 1 MPas and 20 MPas;
said liquid slush has between 45% and 80% dry matter weight, preferably still between 60% and 80% dry matter weight, preferably still between 65% and 75% dry matter weight, preferably still between 70% and 75% dry matter weight;
the weighted proportions of hydroxyapatite, of said at least one blowing agent, of said at least one binding agent and said at least one dispersing agent are as follows:
   70% to 94% hydroxyapatite,
   5% to 20% blowing agent,
   0.5% to 5% binding agent,
   0.5% to 5% dispersing agent,

the percentages being expressed in weight in relation to the total dry matter weight of the liquid slush;
said canal mould is reproduced by 3D printing;
said heat treatment of step e) comprises a phase of heating said raw material comprising the canal mould from step d) in order to reach a temperature preferably higher than 1200° C., preferably between 1200° C. and 1400° C., preferably between 1200° C. and 1300° C., preferably at a temperature between 1225° C. and 1275° C.;
in step b), said liquid slush (2) is poured in whole or in part only from the height of said canal mould (4) so that the cavity of the canal simulator defining the root canal goes through it.

An objective of the invention also relates to an artificial endodontic canal simulator likely to be obtained by the method for preparing an artificial endodontic canal simulator according to the invention.

Other characteristics and advantages of the invention will appear more clearly upon reading the following detailed description, given as an illustrative and non-exhaustive example, as well as upon reading the examples and appended figures.

### FIGURES

FIG. 1: Transparent diagrams of the steps b)-e) of the method according to the invention (with cross-section representations of the raw material comprising the canal mould obtained in step d), and of the canal simulator according to the invention obtained in step e)).

FIG. 2: X-ray diffractogram of natural dentine and synthetic hydroxyapatite.

FIG. 3: Development of the viscosity of a liquid slush according to the invention, according to the speed gradient applied.

A: liquid slush at 65% dry matter;

B: liquid slush at 70% dry matter;

C: liquid slush at 75% dry matter.

FIG. 4: Representation of the porosity of the material of an endodontic canal simulator according to the invention, according to the quantity of blowing agent (rice starch).

FIG. 5: SEM images of a natural human dentine and of the material of an endodontic canal simulator according to the invention.

FIG. 6: Representation of the hardness (HV) of the material of an endodontic canal simulator according to the temperature of the heat treatment applied (“sintering temperature”).

FIG. 7: Representation of the hardness (HV) of the material of an endodontic canal simulator according to the invention, according to the quantity of blowing agent (rice starch).

FIG. 8: Dilatometry diagram of different materials of an endodontic canal simulator according to the invention, obtained from slushes at 65%, 70%, 75% dry matter weight. The withdrawal ratio during densification is recorded dL/LO %.

FIG. 9: Photographs of an artificial endodontic canal simulator according to the invention at the step of fitting the cone during an endodontic treatment.

FIG. 10: X-rays of the successive steps of an initial endodontic treatment: on a natural tooth (a-d), and on an artificial endodontic canal simulator according to the invention (e-h).

FIG. 11: Representation of the penetration thickness of different adhesive systems (SAM I, M&R II) (μm) in a canal simulator according to the invention (“artificial dentine”) and in a natural dentine (“natural dentine”).

### DETAILED DESCRIPTION OF THE INVENTION

The invention relates to an artificial endodontic hydroxyapatite-based canal simulator comprising a cavity representing a root canal, said artificial endodontic canal simulator having a porosity of between 10% and 40%, preferably between 10% and 30%, and a Vickers Hardness of 50HV to 200HV.

In the present application, the use of “between X and Y” must include the limits, X and Y.

Natural dentine is composed of hydroxyapatite (around 70% weight), of organic compounds, of which in particular type 1 collagen (around 20% weight), and water (around 10% weight). The canal simulator of the invention is, itself also, formed mainly of hydroxyapatite. This distinguishes it from canal simulators made from resins.

The porosity (in %) corresponds to the ratio of the volume of material voids in relation to the total volume of the material. As a comparison, the porosity of natural dentine of the dental root is typically between 10% and 40% (Vennat et al., Dental Materials (2009) 25:729-735). The porosity of the artificial endodontic canal simulator of the invention is therefore close to that of natural dentine, in that it is between 10% and 40%, preferably between 10% and 30%, preferably still between 15% and 25%. Typically, the porosity of the artificial endodontic canal simulator of the invention is around 20%.

The porosity can be determined by any method known by a skilled person. The method of determining the porosity defined in the examples can typically be used, in other words, the hydrostatic weighing method.

Advantageously, the average size of pores is between 2 μm and 10 μm (micrometres), preferably between 3 μm and 6 μm, preferably still between 4 μm and 5 μm, preferably still around 4.5 μm. The average size of pores can be determined by any method known by a skilled person. The average size of pores can typically be determined by scanning electron microscopy (SEM) image processing.

The hardness of the simulator according to the invention is expressed in Vickers Hardness (HV) under normal temperature and pressure conditions. As a comparison, the hardness of the natural dentine of the dental root is typically around 69HV. The hardness of the artificial endodontic canal simulator of the invention is therefore close to that of natural dentine, in that it is from 50HV to 200HV, preferably from 60HV to 160HV. The hardness varies, in particular, according to the weighted percentage of blowing agent comprised in the liquid slush. The higher the weighted percentage of blowing agent, the softer the simulator according to the invention will be. Vickers Hardness is typically measured using a square-based pyramidal indenter according to the standard, ISO 14705:2008.

The dilatometry represents the linear dilatation of an object according to the temperature. It enables to determine the withdrawal ratio of a material according to the densification thereof during the application of a heat treatment. The withdrawal ratio is thus expressed as a withdrawal percentage, in relation to the initial volume of the material. In order to measure the withdrawal ratio, a dilatometer can be used, of which the temperature increases by 5° C. every 5 minutes up to 1400° C., for example, a Netzsch DL402 dilatometer. As highlighted in the examples, the withdrawal ratio of an artificial canal simulator according to the invention measured by dilatometry after heat treatment at 1400° C. is preferably between 5% and 25% of the initial volume, preferably still between 10% and 20% of the initial volume.

Said mechanical characteristics of the canal simulator according to the invention give it particularly useful properties, in particular in the area of research and education. Indeed, the artificial canal simulator according to the invention has, with these characteristics, a microstructure and an anatomy close to a natural dental root. This enables, for example, tests to be carried out with an educational or research purpose, on a material that reacts closely to natural dentine. It is, for example, possible to make comparisons of interfaces or to carry out putty/endodontic adhesive penetration tests in the artificial endodontic canal simulator of the invention. It is indeed possible to carry out binding of adhesive systems, the adhesive character of the simulator according to the invention being close to that of natural dentine.

The present invention also relates to a method enabling the manufacture of an artificial endodontic canal simulator according to the invention.

An objective of the present invention thus relates to a method for preparing an artificial endodontic hydroxyapatite-based canal simulator comprising a cavity representing a root canal, said method comprising the steps consisting of:

a) preparing a liquid slush comprising hydroxyapatite, at least one blowing agent, at least one binding agent, at least one dispersing agent and water;

b) pouring said liquid slush into a container wherein a canal mould is placed;

c) drying said liquid slush order to obtain a raw material comprising said canal mould;

d) removing said raw material comprising said canal mould from the container;

e) thermally processing said raw material comprising said canal mould in order to form said cavity defining the root canal by combusting said canal mould and obtaining said artificial endodontic canal simulator.

The preparation method according to the invention thus uses a negative mould mechanism, by leaving a print of the canal part of a dental root (or root canal of a tooth) by the intermediary of a mould representing the volume of this canal part, here called a “canal mould”. After having removed the canal mould, a simulator composed of a material close to the mineral phase of natural dentine is obtained, and a material that has the print of the desired canal part.

The liquid slush prepared in step a) comprises hydroxyapatite, at least one blowing agent, at least one binding agent, at least one dispersing agent and water. This preparation step a) consists of a mixture of these compounds.

Preferably, the step a) of preparing a slush comprises a fusing step. Such fusing can be carried out according to any method known to a skilled person, for example, using a turn jar. Preferably, the fusion step is carried out before adding said at least one binding agent in said liquid slush. This adding order is advantageous to avoid breaking the molecular chains of the binding agent during the mixture.

Preferably, the step of preparing a slush comprises the addition of water and the dispersing agent, following by the addition of the blowing agent and hydroxyapatite, followed by a fusion step, following by the addition of the binding agent.

The hydroxyapatite used, of the formula Ca₅(PO₄)₃(OH), can be commercially available hydroxyapatite, or it can be prepared according to any method known by a skilled person. Typically, the hydroxyapatite used to form the liquid slush can be prepared by aqueous precipitation, for example, in the same way as in the examples in the present application. Preferably, the hydroxyapatite particles have a size of around 1 μm. Moreover, advantageously, the density of the hydroxyapatite is close to that of natural dentine and is preferably between 2.5 g·cm⁻³ and 4 g·cm⁻³, preferably between 3 g·cm⁻³ and 3.5 g·cm⁻³, preferably still around 3.2 g·cm⁻³.

The quantity of hydroxyapatite is preferably from 70% to 94%, preferably from 80% to 90%, preferably still from 85% to 90% weight, in relation to the total weight of liquid slush.

By “blowing agent”, this means a compound that is entered into the liquid slush in the form of particles, these particles decomposing then during a heat treatment, like for example, that carried out in step e), to leave voids or pores within the mixture.

The size of the particles of a blowing agent according to the invention is preferably smaller than 10 microns (μm), preferably still between 1 and 8 microns (μm), preferably still between 6 and 8 microns (μm). A blowing agent according to the invention is, for example, but not exhaustively, chosen from among starches, organic polymers, graphite and resins. Preferably, a blowing agent is chosen from among starches. Preferably still, this is rice starch.

The quantity of blowing agent is preferably from 5% to 20%, preferably still from 7.5% to 12.5%, preferably still around 10% weight, in relation to the total weight of liquid slush. The quantity of blowing agent added to the liquid slush determines, in particular, the porosity of the artificial canal simulator. It is thus possible to control the porosity of this simulator by using an appropriate quantity of blowing agent.

The use of one or several binding agent(s) enables both to increase the mechanical resistance of the raw material obtained after drying in step c), and to limit the appearance of microfissures likely to be formed during the drying step c).

As a binding agent, in particular a compound is chosen, or a mixture of compounds, chemically compatible with the other components of the slush. Water-soluble compounds are more specifically appropriate. A binding agent according to the invention is, for example, but not exhaustively, chosen from among polyacrylic compounds and polyvinyl compounds. Preferably, a binding agent according to the invention is a polyacrylic compound, in particular an acrylic latex such as B1001® commercialised by Rohm and Haas.

The quantity of binding agent is preferably from 0.5% to 5%, preferably from 1% to 2% weight, in relation to the total weight of liquid slush.

The use of one or several dispersing agent(s) enables, in particular, to increase the ratio of dry matter by preserving a low viscosity of slush. A dispersing agent according to the invention is, for example, but not exhaustively, chosen from among water-soluble polymers, homopolymers, or organic or inorganic copolymers, preferably of a molar mass of between 10000 g·mol⁻¹ and 40000 g·mol⁻¹. Preferably, a dispersing agent according to the invention is chosen from among water-soluble polymers. Preferably still, a dispersing agent according to the invention is ammonium polymethacrylate.

The quantity of dispersing agent is preferably from 0.5% to 5%, preferably from 1% to 3% weight, in relation to the total weight of liquid slush.

In order to obtain a liquid slush, water is added in the necessary quantity. Generally, the more the ratio of dry matter increases, the more the viscosity of the slush increases.

Preferably, the dynamic viscosity p of the slush is between 0.4 MPas and 30 MPas, preferably still between 1 MPas and 20 MPas. “Dynamic viscosity” means the viscosity measured with a fixed shear stress when an established provision is reached. The dynamic viscosity can be measured by dynamic rheometry, by measuring the shear stress transmitted by viscoelastometry, according to the speed gradient applied. The experimental part can thus be referred to. When the term “viscosity” is used in the present application, this is dynamic viscosity.

Preferably, the reference viscosity μ₀ of the slush is between 0.5 MPas and 100 MPas, preferably still between 8 MPas and 80 MPas, preferably still between 60 MPas and 80 MPas. “Reference viscosity” means the viscosity measured at to.

Advantageously, water is added in order to obtain a percentage of dry matter weight of the liquid slush, preferably between 45% and 80%, preferably still between 60% and 80%, preferably still between 65% and 75%, preferably still between 70% and 75%. Generally, a slush that has less than 70% dry matter weight will have a Newtonian rheological effect, which gives the advantage of facilitating the pouring step b), the slush remaining liquid after mixture and fusion. On the contrary, a slush that has more than 70% dry matter weight will have a dilatant flow effect, the viscosity of the slush tending to increase when the speed gradient increases. Beyond 80% dry matter, it is therefore difficult to carry out step d) of the method, consisting of removing the raw material from the container, that is the dried slush. Given that it is preferable to have a dry matter ratio as high as possible, in particular, in order to limit the duration of the drying step c), a dry matter ratio of between 65% and 75%, and preferably still between 70% and 75%, advantageously enables to have a slush that can be handled, with an increased dry matter ratio.

Thus, according to a specific embodiment, the liquid slush has between 45% and 80% dry matter weight, preferably still between 60% and 80% dry matter weight, preferably still between 65% and 75% dry matter weight, preferably still between 70% and 75% dry matter weight.

Generally, the hydroxyapatite/blowing agent/binding agent/dispersing agent/water proportions are adapted according to the application targeted. Advantageously, the weighted proportions of hydroxyapatite, of said at least one blowing agent, of said at least one binding agent, and of said at least one dispersing agent are as follows:
70% to 94%, preferably from 80% to 90%, preferably still from 85% to 90% hydroxyapatite,
5% to 20%, preferably from 7.5% to 12.5% blowing agent,
0.5% to 5%, preferably from 1% to 2% binding agent,
0.5% to 5%, preferably from 1% to 3% dispersing agent,
   the percentages being expressed in weight, in relation to the total dry matter weight of the liquid slush.

The hydroxyapatite mixture, of said at least one blowing agent, of said at least one binding agent, of said at least one dispersing agent and water, can be made in whichever order, indifferently. Preferably, the step of preparing a slush comprises the addition of water and the dispersing agent, followed by the addition of the blowing agent and hydroxyapatite, followed by the addition of the binding agent. This order of addition is advantageous to avoid breaking the molecular chains of the binding agent during the mixture.

As outlined above, the preparation step a) preferably comprises a fusion step. Preferably, said fusion step is carried out before adding the binding agent during step a).

An additional step of degassing the liquid slush can also be carried out downstream of the preparation step a). This degassing step consists of removing the gases contained in the liquid slush and is typically carried out in a vacuum, for example, under an atmospheric pressure going from 0.1 atm to 0.5 atm, preferably around 0.2 atm, and for a duration of 5 minutes to 30 minutes, preferably around 10 minutes.

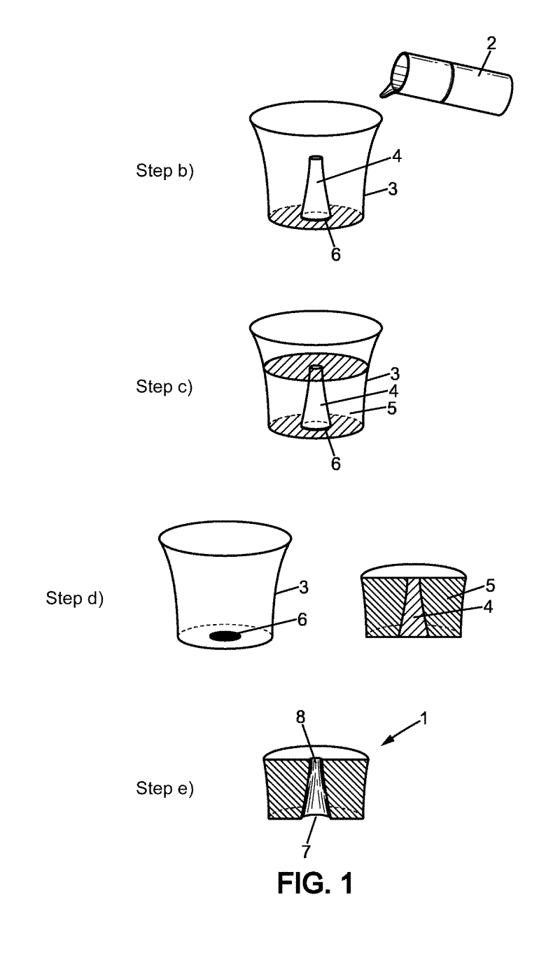

FIG. 1 represents the steps b) to e), following the method of preparing an artificial endodontic canal simulator 1 according to the invention.

In step b), the liquid slush 2 obtained in step a) (not represented in FIG. 1) is poured into a container 3, wherein a canal mould 4 is placed. Said canal mould 4 reproduces the full volume of a canal part of a dental root and is intended to leave the print of the contours thereof in the artificial canal simulator 1 according to the invention after having fused during the heat processing step e).

The canal mould 4 is thus composed of a material appropriate to the present invention. In particular, the material used is able to decompose, in particular to burn during heat treatment carried out in step e) of the method. The canal mould 4 can, for example, be made of resin or of wax.

The mould 4 reproducing the external form of a canal part of a tooth can be produced according to any method known by a skilled person, and appropriate to the present invention. Generally, the canal part of a tooth has a decreasing cross-section from the coronary area to the apical area of the tooth. According to a specific embodiment, the method according to the invention comprises an additional step for producing a canal mould 4. This additional step is typically implemented upstream of step b).

According to a particularly advantageous embodiment enabling to represent the complex shape of root canals of teeth in the canal simulator 1 of the invention, the canal mould 4 is produced by 3D printing.

Advantageously, the step of producing a canal mould 4 comprises the following steps:
a construction step during which a 3D model of the canal mould is constructed,
a step of reproducing a canal mould in 3D from the 3D model of the canal mould, with, in particular, a maximum printing resolution of 12 μm, preferably between 12 μm and 35 μm, preferably still between 12 μm and 30 μm.

The 3D model of the canal mould can be made on a computer, abstractly or from models, for example, from natural teeth.

Thus, according to a specific embodiment, the step of producing a canal mould 4 comprises the following steps:
an acquisition step, during which at least one 2D image is acquired, representative of a cross section of the internal structure of at least one natural tooth,
a detection step, during which the volume of the canal part is detected in said at least one 2D image of the volume of the canal part of each cross section,
a construction step, during which a 3D model of the volume of the canal part is constructed,
a step of reproducing a canal mould in 3D, with, in particular, a maximum printing resolution of 12 μm, preferably between 12 μm and 35 μm, preferably still between 12 μm and 30 μm.

Typically, according to this embodiment, during the acquisition step, natural teeth are scanned by microtomography, in order to serve as a model for the 3D reproduction of the canal mould 4.

Preferably, the canal mould 4 reproduced by 3D printing is made of wax.

According to an advantageous embodiment, the volume of the canal mould is oversized according to the withdrawal ratio of the prepared canal simulator, as previously defined. The print left by the canal mould after heat treatment is thus closer to the size of a natural tooth.

As can be seen in FIG. 1, the canal mould 4 is thus placed in the container 3 intended to receive the liquid slush 2. Any appropriate container 3 can be used. According to a specific embodiment, a cylindrical mould can be used. An adhesive means 6 enabling the adhesion of the canal mould to the bottom of the container can be provided, for example, a wax area. The adhesive means is preferably able to come loose from the canal mould during being released from the mould in step d). As represented in FIG. 1, the canal mould is placed in the container, the largest-sized part of the mould being held using the adhesive means 6. In order to facilitate being released from the mould, a mould in several parts can, for example, be used.

According to an advantageous embodiment, the material used for the container 3 enables the absorption of water comprised in the liquid slush 2. For example, this can be plaster. From step b), a container 3 is obtained, comprising a canal mould 4, wherein the liquid slush 2 is placed.

In FIG. 1, a specific embodiment of the invention is represented, according to which the slush is poured in whole or in part only from the height of the canal mould. Thus, at the end of the method, a canal simulator is obtained, of which the cavity crosses, in order to, for example, be able to eliminate treatment solutions. Advantageously, a first “wide” mouth 7 thus corresponds to the widest-sized section of the canal, whereas a second “narrow” mouth 8 defines the tip of the root. The pouring height of the slush and/or the size of the canal mould are determined, in particular, so that the sizes of the mouths 7 and 8 are as close as possible to the sizes of a natural dental canal.

According to another specific embodiment of the invention, in step b), said liquid slush (2) is poured beyond the height of said canal mould (4), so that the cavity of the canal simulator defining the root canal does not go through it.

Step c) thus consists of drying the liquid slush 2 in order to obtain a raw material 5 comprising said canal mould 4. In other words, the slush, once dried, gives a hard material called “raw material” 5 surrounding the canal mould 4 placed in the container 3.

The drying step can be implemented by any method known by a skilled person and appropriate to the present invention. Typically, the liquid slush 1 from step b) dries at room temperature for at least 1 hour, preferably for at least 2 hours, preferably still for at least 3 hours. Drying at room temperature enables to avoid the appearance of fissures which could be formed in the case of drying at a higher temperature.

As represented in FIG. 1, the raw material 5 comprising the canal mould 4 is then removed or released from the mould of the container 3 during a step d). Therefore, from this step d), a raw material 5 still comprising the canal mould 4 is obtained.

An additional drying step can possibly be implemented from this step d) of releasing from the mould of the raw material 5 and before heat treatment step e). Such an additional drying step can be implemented by any method known by a skilled person and appropriate to the present invention. Typically, the raw material 5 from step d) dries at room temperature for around 24 hours. In the same way as above, drying at room temperature enables to avoid the appearance of fissures which could be formed in the case of drying at a higher temperature.

Step e) of heat treating the raw material 5 comprising the canal mould 4 is finally implemented in order to cause a combustion of said canal mould 4 and to obtain said artificial endodontic canal simulator 1.

This heat treatment step is carried out according to any method known by a skilled person and appropriate to the present invention. In particular, this heat treatment step must be conducted in order to achieve several objectives.

The temperature of the heat treatment must first enable the combustion of the canal mould 4. As outlined above, the material used to reproduce the canal mould 4 is indeed able to burn at the temperatures implemented. Therefore, from the heat treatment phase e), a “negative mould” is obtained, in other words, a material that has the print of the contours of the canal mould, that is the volume of a canal part.

Moreover, the heat treatment step must enable the hydroxyapatite-based material to be densified and to remove the blowing agent in order to generate the porosity of the product. The material of the canal simulator 1 obtained after heat treating the raw material 5 of step d), is thus totally densified and has the desired porosity.

The temperature of the heat treatment must thus be determined so as to obtain the artificial canal simulator 1 of the invention, in other words, a material that has the print of the volume of a canal part, the material being completely densified and having an appropriate porosity, obtained thanks to eliminating the heat from the blowing agent.

Preferably, the heat treatment of step e) comprises a phase of heating the raw material 5 comprising the canal mould 4 from step d), in order to reach a temperature enabling the degradation of the canal mould 4 and the blowing agent, as well as the densification of the hydroxyapatite. Preferably, the heat treatment is carried out at a temperature higher than 1200° C., preferably between 1200° C. and 1400° C., preferably between 1200° C. and 1300° C., preferably at a temperature between 1225° C. and 1275° C. Above 1200° C., the hydroxyapatite-based material is indeed entirely densified. Moreover, the higher the heat treatment temperature, the harder the material. This heating phase can be carried out progressively, for example, by making the temperature increase by 300° C. every hour.

Advantageously, one or several lag phases consisting of maintaining a determined temperature for a determined duration can be implemented for the heating phase of the heat treatment.

Preferably, a lag phase of the heating phase of the heat treatment is carried out when the temperature is between 400° C. and 700° C., preferably between 500° C. and 650° C., preferably still around 600° C. Preferably, said temperature is maintained for a duration between 1 hour and 6 hours, preferably for around 3 hours. Typically, the lag phase can consist of maintaining the temperature at 600° C. for 3 hours. Such a lag phase enables the elimination of carbon released during the combustion of the blowing agent.

Preferably, another lag phase is carried out at the end of the heating step, when the desired temperature is reached. Preferably, said temperature is maintained for a duration of between 2 hours and 5 hours, preferably for around 3 hours. Typically, the lag phase can consist of maintaining the temperature at 1225° C. for 3 hours.

According to an embodiment, the heat treatment comprises, after the heating step, a phase consisting of cooling the material to a temperature of between 20° C. and 50° C., preferably between 30° C. and 45° C., preferably still at a temperature of around 40° C. This second cooling phase can be carried out progressively, for example, by making the temperature fall by 20° C. to 100° C. every hour, preferably by 30° C. every hour. Such a progressive decrease of the temperature enables, among others, to avoid the heat shock which could occur with hydroxyapatite.

The artificial endodontic canal simulator 1 obtained from the method has the advantage of having a composition, a microstructure and an anatomy close to the mineral phase of the dentine of the natural dental root. This simulator reacts to the surrounding conditions (for example, to the temperature, pressure, present of fluid among others), very closely to the natural tooth. Moreover, this canal simulator has the advantage of being radiopaque, and thus being able to be viewed on X-rays.

An objective of the invention also relates to an artificial endodontic canal simulator 1 likely to be obtained by the method for preparing an artificial endodontic canal simulator according to the invention. Such a simulator 1 has the physico-mechanical characteristics outlined above.

The artificial endodontic canal simulator 1 can, in particular, be used for research or education purposes.

The invention is defined in further detail below, using the following examples which are not at all exhaustive, but are given only as examples.

### EXAMPLES

### Example 1: Preparation and Characterisation of a Hydroxyapatite Powder

### Materials and Methods

Hydroxyapatite powder (HA) has been synthesised by aqueous precipitation. Two aqueous calcium nitrate solutions Ca(NO₃)₂4H₂O (Honeywell, Cranves Sales) and ammonium phosphate (NH₄)₂HPO₄ (Carlo Erba, Val de Reuil) have been incubated in a reactor, thermostatically-controlled at 60° C., 50 rpm for 24 hours.

The solution has then been filtered and dried at 70° C. for 7 days. In order to decrease the dispersion of the hydroxyapatite in the water and to remove the nitrate residue, the specific surface area of the hydroxyapatite powder has been reduced by calcination at 950° C. for 3 hours. The agglomerates formed during the calcination have been separated by grinding for 24 hours, 100 rpm.

The product has been characterised by diffraction of X-rays (X'Pert Pro MRD, Panalytical) and compared with the natural dentine coming from healthy maxillary molar teeth extracted from patients aged 25 years old to 45 years old for orthodontic reasons.

### Results

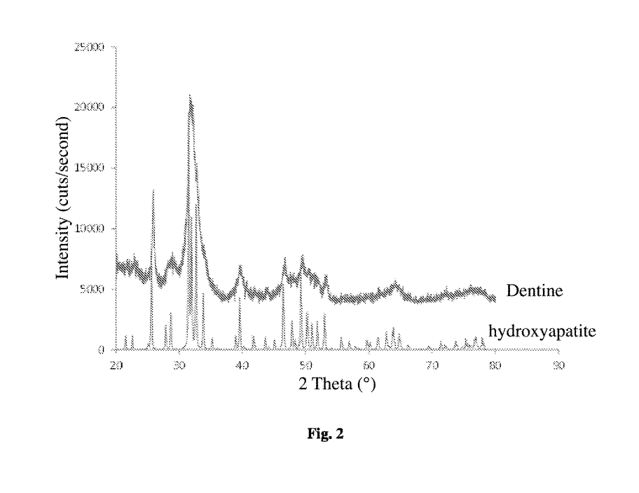

As can be seen in FIG. 2, the synthesised hydroxyapatite powder is highly crystallised and pure. Natural dentine is, itself, partially crystallised and the spectrum thereof corresponds to the present of hydroxyapatite. The hydroxyapatite powder, synthesised at a density of 3.2 g·cm⁻³.

### Example 2: Analysis of the Viscosity of a Slush

### Materials and Methods

Three liquid slushes have been prepared. Ammonium polymethacrylate (Darvan C, Vanderbilt Minerals) (dispersing agent) has been mixed with water, then the hydroxyapatite powder prepared according to example 1 and rice starch with an average granulometry of 7 μm (Remy, from the company Remy Industries, France) (blowing agent) have been added. The compounds have been mixed in a turn jar containing zirconia balls (100 rpm, 1 hour), then acrylic latex (B1001, Rohm and Haas) (binding agent) has been added.

The three prepared slushes respectively have 65%, 70% and 75% dry matter weight. The respective quantities of each compounds in relation to the total dry matter weight of the slush are defined in table 1 below.

TABLE 1

| | | Slush at | Slush at |
|---|---|---|---|
| | Slush at 65% dry | 70% dry | 75% dry |
| | matter weight | matter weight | matter weight |
| Hydroxyapatite | 87.3% | 87.3% | 87.3% |
| Rice starch (Remy, | 10% | 10% | 10% |
| Remy Industries) | | | |
| Acrylic latex | 1.4% | 1.4% | 1.4% |
| (B1001, Rohm and | | | |
| Haas) | | | |
| Ammonium | 1.3% | 1.3% | 1.3% |
| polymethacrylate | | | |
| (Darvan C, | | | |
| Vanderbilt | | | |
| Minerals) | | | |

Dynamic rheometry has been used to determine the viscosity of the slushes (Gemini rheometer, Bohlin). A sheer ratio has been applied, and the sheer stress transmitted by the sample has been evaluated by viscoelastometry. The slushes have been inserted between the two viscometer plates. The bottom plate has been maintained at 20° C.±0.2° C. in an atmosphere using a thermostatically-controlled bath (flat truncated cone, 2°, 55 mm, gap 70). Under these conditions, it has been possible to study the development of the sheer stress according to the speed gradient. The dynamic sheer stress τ for a test has been selected when this has reached an established dynamic provision (3 samples/group). It has thus been possible to measure the dynamic viscosity, as well as the reference viscosity μ₀, determined at t₀.

### Result

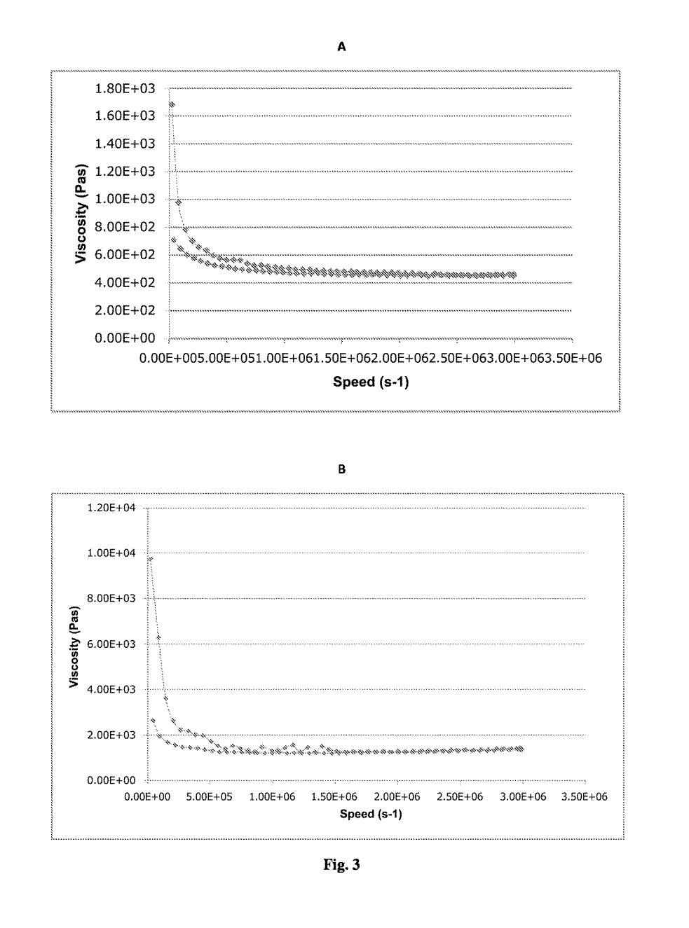

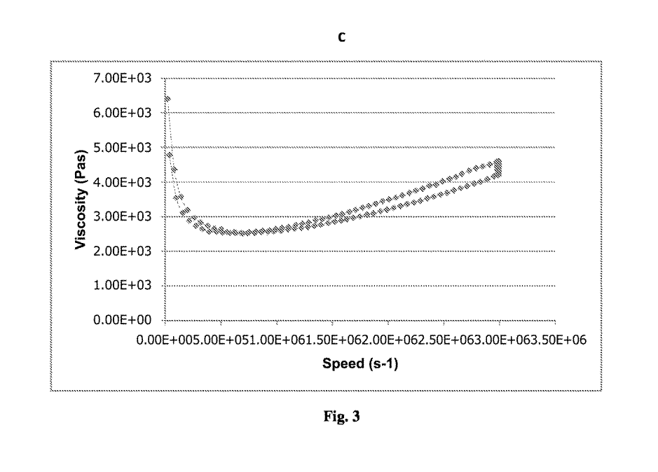

As represented in FIG. 3, the slushes at 65% and 70% dry matter weight have a Newtonian effect, in other words, the deformation stress/speed law is linear. Slush at 75% dry matter weight has a dilatant flow effect, in other words, the viscosity increased under the effect of a stress.

Table 2 below presents the reference viscosities go of the slushes at 65%, 70% and 75% dry matter weight.

TABLE 2

| | Reference | |
|---|---|---|
| | viscosity μ₀ | |
| Slush | (MPas) | Dynamic viscosity (MPas) |
| Slush at 65% dry matter | 1.6 ± 0.08 | 0.65 ± 0.2 |
| weight | | |
| Slush at 70% dry matter | 9.7 ± 1.4 | 1.3 ± 0.45 |
| weight | | |
| Slush at 75% dry matter | 68.4 ± 13.6 | 12.03 ± 6.8 |
| weight | | |

Slushes at 70% and 75% dry matter weight form a good compromise, in that it remains that they can be handled easily, while having a dry matter ratio as high as possible.

### Example 3: Analysis of the Porosity of the Material of an Artificial Endodontic Canal Simulator

### Materials and Methods

Five liquid slushes have been prepared in the same way as defined in example 2, with 75% dry matter and with different quantities of blowing agent (rice starch of an average granulometry of 7 μm (Remy, from the company Remy Industries, France)) (2.5%, 10%, 15%, 20%, 25% dry matter weight) and hydroxyapatite. The respective quantities of each compound in relation to the total dry matter weight of slush are defined in table 3 below.

TABLE 3

| | Test | Test | Test | | |
|---|---|---|---|---|---|
| | no. 1 | no. 2 | no. 3 | Test no. 4 | Test no. 5 |
| Hydroxyapatite | 94.8% | 87.3% | 82.3% | 77.3% | 72.3% |
| Rice starch | 2.5% | 10% | 15% | 20% | 25% |
| (Remy, Remy | | | | | |
| Industries) | | | | | |
| Acrylic latex | 1.4% | 1.4% | 1.4% | 1.4% | 1.4% |
| (B1001, Rohm | | | | | |
| and Haas) | | | | | |
| Ammonium | 1.3% | 1.3% | 1.3% | 1.3% | 1.3% |
| polymethacrylate | | | | | |
| (Darvan C, | | | | | |
| Vanderbilt | | | | | |
| Minerals) | | | | | |

After fusion for 1 hour at 120 rpm in a turn jar (Turn jar, 28A20, Faure Equipments), and degassing in a vacuum (0.2 atm, 10 minutes), the liquid slushes have been poured into the wells of a 24-well plate and left at room temperature for 3 hours in order to dry. The raw materials obtained after drying have then been released from the mould and heat treated in a ceramic furnace (LHT 08/17; Nabertherm) with a first heating phase of 300° C. every hour, making the temperature go from 40° C. to 600° C. with a lag phase of 3 hours, during which the temperature has been maintained at 600° C., followed by a second heating phase from 600° C. to 1225° C. with a 3-hour stage, during which the temperature has been maintained at 1225° C. The temperature has then been reduced to 40° C. with a decrease of 30° C. every hour.

The porosity of the samples has been determined by hydrostatic weighing on a precision scale (ALT-310-4 AM; Kern) by using the Archimedes principle (3 vacuum cycles, 3 samples/group).

The microstructure of the samples comprising 10% starch in dry matter weight has been observed by scanning electron microscope (S-3500N; Hitachi, Tokyo, Japan) (high vacuum, secondary electrons), after gold metallisation (HHV auto360; Edwards, Crawley, England).

### Results

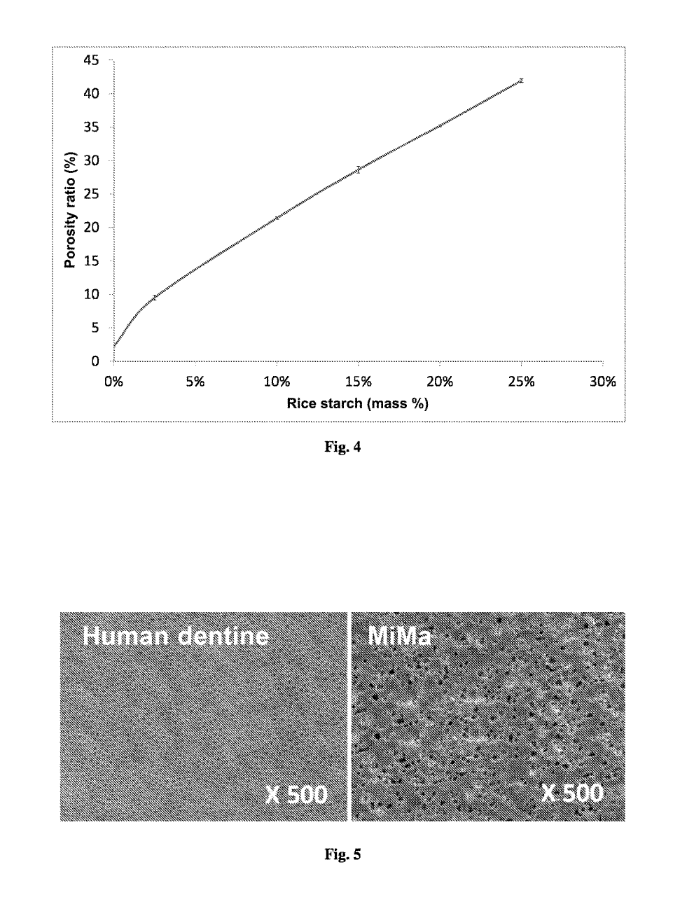

As can be seen in FIG. 4, materials comprising 10% rice starch weight show a porosity of 20%, which is similar to the porosity ratio of natural dentine, also 20%.

Moreover, as can be seen in FIG. 5, the material of the canal simulator according to the invention has a microporous structure close to natural dentine, in terms of the size of the pores and the porosity ratio.

### Example 4: Analysis of the Hardness of the Material of an Artificial Endodontic Canal Simulator

### Materials and Methods

Seven liquid slushes have been prepared in the same way as defined in example 2, with 75% dry matter and with different quantities of blowing agent (rice starch) (0%, 2.5%, 7.5%, 10%, 12.5%, 15%, 20% of the total dry matter weight).

The respective quantities of each compound, in relation to the total dry matter weight of slush are defined in table 4 below.

TABLE 4

| | Test | Test | Test | Test | Test | Test | Test |
|---|---|---|---|---|---|---|---|
| | no. 6 | no. 7 | no. 8 | no. 9 | no. 10 | no. 11 | no. 12 |
| Hydroxyapatite | 97.3% | 94.8% | 89.8% | 87.3% | 84.8% | 82.3% | 77.3% |
| Rice starch | 0% | 2.5% | 7.5% | 10% | 12.5% | 15% | 20% |
| (Remy, Remy | | | | | | | |
| Industries) | | | | | | | |
| Acrylic latex | 1.4% | 1.4% | 1.4% | 1.4% | 1.4% | 1.4% | 1.4% |
| (B1001, Rohm | | | | | | | |
| and Haas) | | | | | | | |
| Ammonium | 1.3% | 1.3% | 1.3% | 1.3% | 1.3% | 1.3% | 1.3% |
| polymethacrylate | | | | | | | |
| (Darvan C, | | | | | | | |
| Vanderbilt | | | | | | | |
| Minerals) | | | | | | | |

A first group of canal simulator materials has then been made in the same way as in example 3 from slush without blowing agent (0%), by making the heat treatment temperature (“sintering temperature”) vary. The following temperatures have thus been reached: 1050° C., 1100° C., 1125° C., 1150° C., 1175° C., 1200° C. and 1275° C.

A second group of canal simulator materials has been made in the same way as in example 3 from slushes with and without blowing agent (0%, 2.5%, 7.5%, 10%, 12.5%, 15%, 20%) and with a heat treatment temperature of 1275° C.

The hardness of the samples (12 samples/group) has been measured by Vickers microindentation (Testwell; FM) of a square-based pyramidal diamond (500 g lasting 10 seconds).

### Results

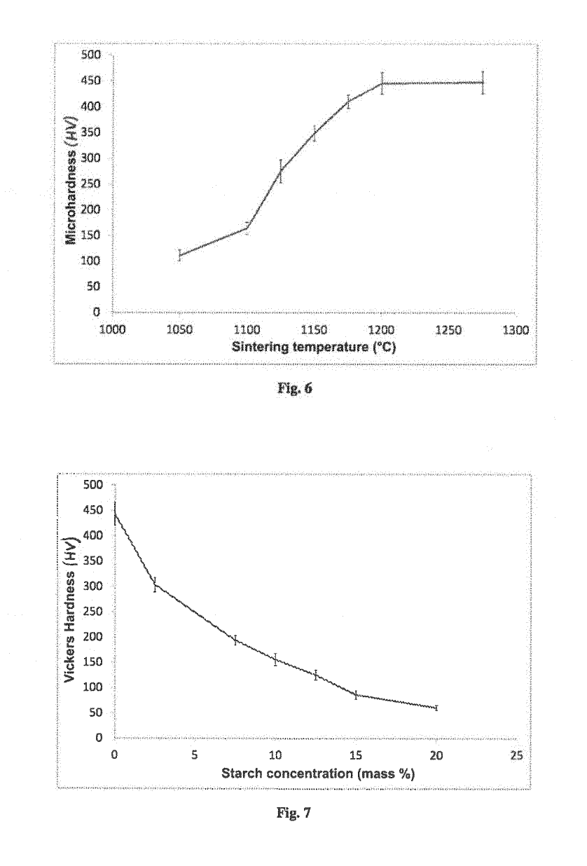

As can be seen in FIG. 6, the material without rice starch is only totally densified beyond 1200° C.

Moreover, as can be seen in FIG. 7, the higher the quantity of blowing agent, the softer the material is. Thus, the material without blowing agent has a hardness of 442HV, the material with 10% blowing agent has a hardness of 155HV, and the material with 20% blowing agent has a hardness of 61HV. The presence of blowing agent therefore enables to obtain a hardness closer to natural dentine. The material comprising 20% blowing agent has substantially the same hardness as natural dentine (69HV).

### Example 5: Analysis of the Dilatometrv of the Material of an Artificial Endodontic Canal Simulator

### Materials and Methods

Three liquid slushes have been prepared in the same way as defined in example 2, with respectively 65%, 70% and 75% dry matter weight. The canal simulator materials according to the invention have then been made in the same way as in example 3.

The withdrawal ratio connected to the densification of the samples has been measured by dilatometry (DL402C, NETZSCH). Cylindrical samples (length 15 mm, diameter 5 mm, 3 samples/group) have been placed on an alumina sample holder then a heat cycle has been applied in an ambient atmosphere (from 40° C. to 1400° C., 5° C./minute; from 1400° C. to 40° C., 5° C./minute).

### Results

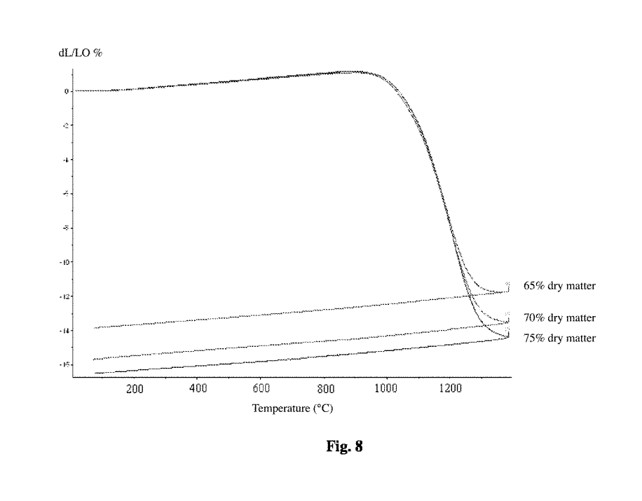

As can be seen in FIG. 8, the withdrawal ratio is higher for a poured sample at 75% dry matter (>16%), than at 65% dry matter (14%). The increase in the withdrawal ratio, in particular enables the canal mould to be oversized, in order to anticipate the loss of matter during the heat treatment.

### Example 6: Preparation of a Canal Simulator According to the Invention

A liquid slush has been prepared in the same way as defined in example 2 with 75% dry matter.

Moreover, a canal mould has been reproduced in wax by 3D printing. For this, 25 healthy, natural teeth extracted from patients for orthodontic, periodontal and/or prosthetic reasons, have been scanned by microtomography (Skyscan 1172, acquisition resolution: 18 μm), in order to serve as a model for the 3D production of a canal mould representing the volume of a physiological canal part. The reconstruction of images has thus been carried out with NRECON software (Skyscan), the selection and isolation of the canal part (pulp volumes) on the images has been carried out with CT-an software, and the simulator has been produced by 3D printing with a cryoceram printer.

The canal mould has then been entered into a plaster container, at the bottom of which an adhesive means has been placed beforehand, in order to make the coronary area (in other words, the highest cross section part of the canal mould) bind to the plaster plate.

After fusion for 1 hour at 120 rpm in a turn jar and vacuum degassing (0.2 atm, 10 minutes), the liquid slush has then been poured into the cylindrical, plaster container and left at room temperature for 3 hours in order to dry. The raw material obtained after drying has then been released from the mould and heat treated in a ceramic furnace (LHT 08/17; Nabertherm) with a first heating phase of 300° C. every hour, making the temperature go from 40° C. to 600° C. with a 3-hour stage, during which the temperature has been maintained at 600° C., followed by a second heating phase from 600° C. to 1225° C. with a 3-hour stage, during which the temperature has been maintained at 1225° C. The temperature has then been reduced to 40° C. with a decrease of 30° C. every hour.

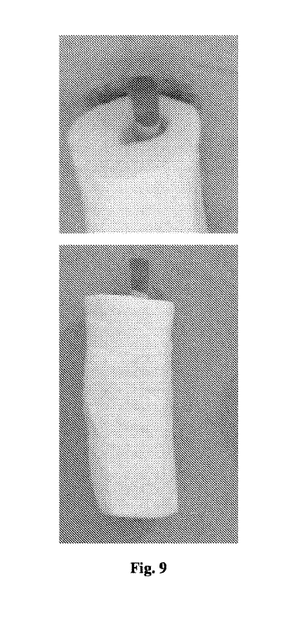

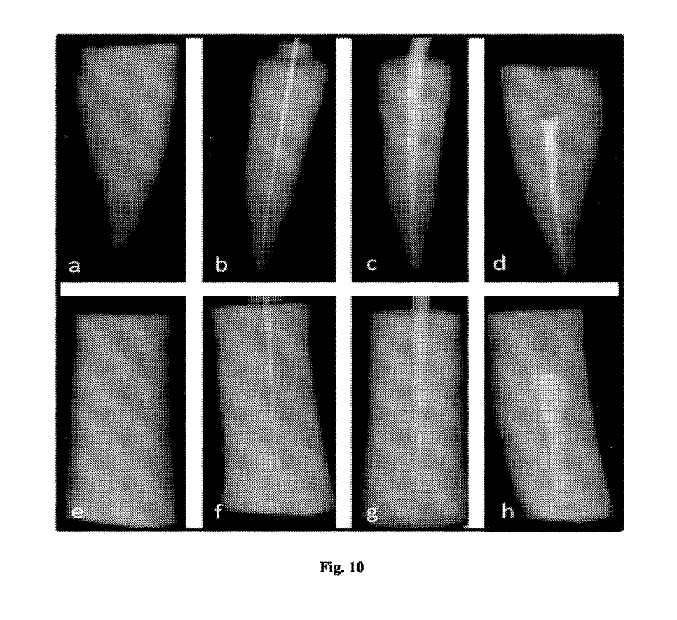

From the method, an artificial canal simulator is obtained, as can be seen in FIG. 9. This canal simulator can, for example, be used by students in order to carry out tests on an anatomical structure close to a natural root canal, and of a composition close to the mineral phase of dentine. As can be seen in FIG. 10, the artificial canal simulator has the advantage of being radiopaque, in the same way as a natural tooth, which enables the process of an endodontic treatment to be followed under conditions close to reality.

As can be seen in FIG. 9, it is, for example, possible to introduce a gutta-percha cone during an endodontic treatment, in order to block the root canal formed in the canal simulator according to the invention. This dental blockage enables to prevent bacterial recontamination. The placing of the cone can be viewed by X-ray as shown in FIG. 10 (steps g and h).

### Example 7: Binding Test on a Canal Simulator According to the Invention

Adhesive systems are used daily by dental surgeons, in particular to reconstitute tooth substance losses (decay, trauma, etc.) by biomaterials. It is therefore important to be able to bind adhesive systems on the canal simulator of the invention, in a way close to natural dentine.

### Materials and Methods

A binding test of a binding resin on the canal simulator prepared according to example 6 has thus been carried out. The penetration thickness of the binding resin has been analysed by a confocal microscope (Leica DCM 3D confocal microscope).

For comparison, a binding test has been carried out on natural dentine. Natural teeth have been cut axially under the deepest occlusal fissure by a 0.5 mm diamond saw (Setocom 15; Struers; Champigne-sur-Marne, France) in order to remove enamel.

Canal simulators have also been prepared in the same way as in example 6.

The surfaces of the natural dentine samples and canal simulators according to the invention have been treated with a mordanting gel containing 37% (v/v) of orthophosphoric acid (Supratech®; R&S, Paris, France) for 3 seconds and have been polished (Labopol-5; Struers) on abrasive discs up to grain 320 (P320; ESCIL) in order to obtain dentine surfaces with a standardised smear layer.

With the binding, the samples have been rinsed with a water spray and air-dried. The samples have then been randomised into 2 groups (n=12) and covered with Optibond® Solo Plus (MR II), a 2-step dental adhesive (Kerr, Orange, Calif., USA), or Futurabond® M (SAM I), a 1-step self-mordanting adhesive (Voco, Cuxhaven, Germany), and have been photopolymerised for 20 seconds at 1200 mW/cm². The natural dentine samples and the canal simulators according to the invention have then been dissolved in a hydrochloric acid solution concentrated at 23%, in order to observe the resin which has penetrated into the porous structure of the substrates. The thickness of the resin layer that has penetrated, has lastly been measured by confocal microscopy (DCM 3D, Leica).

### Results

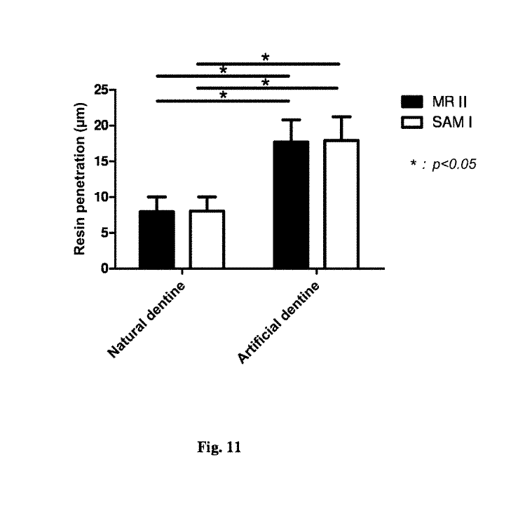

As can be seen in FIG. 11, there is a mechanical integration of the materials bound to the canal simulator, although the penetration thickness of the binding resin is substantially thicker than in natural dentine, which is probably due to the size of the substantially larger pores in the canal simulator.

The mechanical integration observed in the canal simulator therefore enables to use, for example, in practical work for endodontic applications (root canal work and blocking the tooth with bound materials), but also for applications in restorative odontology (reconstitution of substance losses).

### NOMENCLATURE

1. Artificial endodontic canal simulator
2. Liquid slush
3. Container
4. Canal mould
5. Raw material
6. Adhesive means
7. Wide mouth
8. Narrow mouth

1. A hydroxyapatite-based artificial endodontic canal simulator (1), comprising a cavity representing a root canal, said artificial endodontic canal simulator (1) having a porosity of between 10% and 40% and a Vickers Hardness of 50HV to 200HV.

2. A method for preparing an artificial endodontic canal simulator (1) according to claim 1 comprising a cavity defining a root canal, said method comprising the steps of:
a) preparing a liquid slush (2) comprising hydroxyapatite, at least one blowing agent, at least one binding agent, at least one dispersing agent and water;
b) pouring said liquid slush (2) into a container (3) wherein a canal mould (4) is placed;
c) drying said liquid slush order to obtain a raw material (5) comprising said canal mould (4);
d) removing said raw material (5) comprising said canal mould (4) from the container; and
e) thermally processing said raw material (5) comprising said canal mould (4) in order to form said cavity defining the root canal by combusting said canal mould (4) and obtaining said artificial endodontic canal simulator (1).

3. The method according to claim 2, wherein said at least one blowing agent is chosen from among starches, organic polymers, graphite and resins, preferably from among starches.

4. The method according to claim 2, wherein said at least one binding agent is chosen from among polyacrylic compounds and polyvinyl compounds, preferably from among polyacrylic compounds.

5. The method according to claim 2, wherein said at least one dispersing agent is chosen from among water-soluble polymers, homopolymers, or organic or inorganic copolymers, preferably of a molar mass of between 10000 g·mol⁻¹ and 40000 g·mol⁻¹.

6. The method according to claim 2, wherein the viscosity of said liquid slush (2) is between 8 MPas and 100 MPas, preferably still between 60 MPas and 80 MPas.

7. The method according to claim 2, wherein said liquid slush (2) has between 45% and 80% dry matter weight, preferably still between 60% and 80% dry matter weight, preferably still between 65% and 75% dry matter weight, preferably still between 70% and 75% dry matter weight.

8. The method according to claim 2, wherein the weighted proportions of hydroxyapatite, of said at least one blowing agent, of said at least one binding agent and of said at least one dispersing agent are as follows:
70% to 94%, preferably from 80% to 90%, preferably still from 85% to 90% hydroxyapatite,
5% to 20%, preferably from 7.5% to 12.5% blowing agent,
0.5% to 5%, preferably from 1% to 2% binding agent,
0.5% to 5%, preferably from 1% to 3% dispersing agent,
the percentages being expressed in weight, in relation to the total dry matter weight of the liquid slush (2).

9. The method according to claim 2, wherein said canal mould (4) is reproduced by 3D printing.

10. The method according to claim 2, wherein said heat treatment in step e) comprises a phase of heating said raw material (5) comprising the canal mould (4) from step d) in order to reach a temperature, preferably higher than 1200° C., preferably between 1200° C. and 1400° C., preferably between 1200° C. and 1300° C., preferably at a temperature between 1225° C. and 1275° C.

11. The method according to claim 2, wherein in step b), said liquid slush (2) is poured in whole or in part only from the height of said canal mould (4) so that the cavity of the canal simulator defining the root canal goes through it.

12. An artificial endodontic canal simulator (1) obtained by the method according to claim 2.
